(19) United States
(12) Patent Application Publication
(10) Pub. No.: US 2009/0193043 A1
(43) Pub. Date: Jul. 30, 2009

(54) METHOD AND SYSTEM FOR TRANSFORMING DATABASE AND COMPRESSIBLE DATABASE STRUCTURE

(75) Inventor: Duncan Ta-Te Lin, Taipei City (TW)

Correspondence Address: J C PATENTS, INC., 4 VENTURE, SUITE 250, IRVINE, CA, 92618, US

(73) Assignee: INVENTEC CORPORATION, Taipei City (TW)

(21) Appl. No.: 12/021,906

(22) Filed: Jan. 29, 2008

(51) Int. Cl. G06F 17/00

(52) U.S. Cl. 707/101; 707/E17.032

(57) ABSTRACT

A database transforming method suitable for transforming a first database of a host into a second database of a mobile electronic device is provided, wherein the first database has a plurality of original fields. First, a plurality of main fields and a composite field are created in the second database. The main fields are respectively corresponding to at least one of the original fields. The main fields and the composite field are used for displaying data in the original fields. Data displayed in the composite field is separated by separators. Next, data in each field of the first database is written into the corresponding main field or the composite field of the second database. In addition, a compressible database structure and a database transforming system are also provided in the present invention.

### BACKGROUND OF THE INVENTION

1. Field of the Invention

The present invention generally relates to a method, a system, and a structure of a database, in particular, to a method and a system for compressing a database and a compressible database structure.

2. Description of Related Art

In the present age of information explosion, people cannot live their daily life without electronic information, and it has become very common for people to transmit electronic messages and store electronic data by using portable electronic devices, especially mobile communication devices (such as mobile phones or electronic devices with wireless communication functions) and personal digital assistants (PDAs).

Portable electronic devices are usually designed to be very slim and small so that they can be carried around conveniently. However, with limited volume, the performance and storage capacity of a portable electronic device are much lower than those of a general host computer. Accordingly, before a data is transmitted from a host computer to a portable electronic device, the data is usually compressed or converted in order to adapt to the limited performance and storage capacity of the portable electronic device. For example, a large enterprise has many employees, and accordingly the employee contact list could be huge. Whether a mobile communication device or a PDA has enough storage capacity should be considered if the employee contact lest is to be stored into the mobile communication device or PDA.

### SUMMARY OF THE INVENTION

Accordingly, the present invention is directed to a database transforming method which can reduce the storage space required by a database.

The present invention is directed to a compressible database structure which requires less storage space.

The present invention is directed to a database transforming system which can reduce the storage space required by a database.

The present invention provides a database transforming method suitable for transforming a first database of a host into a second database of a mobile electronic device, wherein the first database has a plurality of original fields. In the database transforming method, first, a plurality of main fields and a composite field are created in the second database. The main fields are respectively corresponding to at least one of the original fields, and the main fields and the composite field are used for displaying data in the original fields. Data displayed in the composite field is separated by separators. Next, data in the M^{th} tuple of the first database is read, wherein M is a positive integer. After that, whether or not the N^{th} field of the first database is corresponding to one of the main fields is determined, wherein N is a positive integer. Data in the N^{th} field of M^{th} tuple is written into the corresponding main field when the N^{th} field of the first database is corresponding to one of the main fields. Data in the N^{th} field of M^{th} tuple are written into the composite field when the N^{th} field of the first database is not corresponding to any of the main fields.

According to an embodiment of the present invention, the step of creating the main fields and the composite field in the second database includes determining whether or not a function indicator of each of the original fields is in a first state. When the function indicator of one of the original fields is in the first state, a corresponding main field is created in the second database so that data in the original field can be written into the corresponding main field.

According to an embodiment of the present invention, the step of determining whether or not the N^{th} field of the first database is corresponding to one of the main fields includes determining whether or not the function indicator of the N^{th} field among the original fields is in the first state.

According to an embodiment of the present invention, the step of creating the main fields and the composite field in the second database further includes determining whether or not a function indicator of each of the original fields is in a second state. When the function indicator of one of the original fields is in the second state and no composite field is created yet, the composite field is created in the second database so that data in the original field can be written into the composite field.

According to an embodiment of the present invention, the step of creating the main fields and the composite field in the second database further includes reading a function indicator from a field transform data table to determine whether or not to create one of the main fields or the composite field in the second database.

According to an embodiment of the present invention, the field transform data table includes a first field and a second field, wherein the first field stores the titles of the original fields, and the second field stores the function indicators of the original fields.

According to an embodiment of the present invention, the database transforming method further includes determining whether or not the N^{th} field of the first database is the last field after the step of determining whether or not the N^{th} field of the first database is corresponding to one of the main fields. If the N^{th} field of the first database is not the last field, N=N+1 is executed and the step of determining whether or not the N^{th} field of the first database is corresponding to one of the main fields is executed again. In addition, if the N^{th} field of the first database is the last field, whether or not the M^{th} tuple of the first database is the last row is determined. If the M^{th} tuple of the first database is not the last row, M=M+1 and N=1 are executed and the step of reading data is executed again.

In another aspect, the present invention further provides a compressible database structure suitable for a mobile electronic device to store a first database of a host, wherein the first database has a plurality of original fields. The compressible database structure includes a plurality of main fields and a composite field. The main fields respectively store data in a portion of the original fields, and the composite field stores data in another portion of the original fields, wherein data in each of the original fields stored into the composite field is separated by a separator.

According to an embodiment of the present invention, the compressible database structure further includes a field transform data table. The field transform data table includes a first field and a second field. The first field stores the titles of the original fields, and the second field stores function indicators of the original fields.

According to an embodiment of the present invention, the function indicators of the original fields have a first state or a second state. Data in an original field is stored into one of the main fields if the function indicator of the original field is in the first state, and data in an original field is stored into the composite field if the function indicator of the original field is in the second state.

In another aspect, the present invention also provides a database transforming system including a first database, a second database, and a database transforming module. The first database includes a plurality of original fields. The second database includes a plurality of main fields and a composite field. The main fields respectively store data in a portion of the original fields, and the composite field stores data in another portion of the original fields, wherein data in each of the original fields is separated by a separator. The database transforming module transforms the first database into the second database.

According to an embodiment of the present invention, the database transforming system further includes a field transform data table. The field transform data table includes a first field and a second field. The first field stores the titles of the original fields, and the second field stores function indicators of the original fields. The database transforming module transforms the first database into the second database according to the function indicators of the original fields.

According to an embodiment of the present invention, the function indicators of the original fields have a first state or a second state. The database transforming module stores data in an original field into one of the main fields if the function indicator of the original field is in the first state, and the database transforming module stores data in an original field into the composite field if the function indicator of the original field is in the second state.

According to an embodiment of the present invention, the first database is disposed in a host, the second database is disposed in a mobile electronic device, and the mobile electronic device is connected to the host.

According to an embodiment of the present invention, the database transforming module is disposed in the host or the mobile electronic device.

In the present invention, a composite field is used for storing a plurality of original fields, so that the storage space required by a database can be reduced without losing any data. Moreover, the compressed database can be conveniently restored into its original field format to be displayed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a database transforming system according to an embodiment of the present invention.

FIG. 2A is a diagram of a first database in FIG. 1.

FIG. 2B is a diagram of a second database in FIG. 1.

FIG. 2C is a diagram of a field transform data table in FIG. 1.

FIG. 3 is a flowchart illustrating a method for transforming the first database into the second database in FIG. 1.

FIG. 4 is a flowchart illustrating the step in FIG. 3 for creating a field in the second database.

FIG. 5 is a flowchart illustrating the step in FIG. 3 for transforming data in the first database into the second database.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

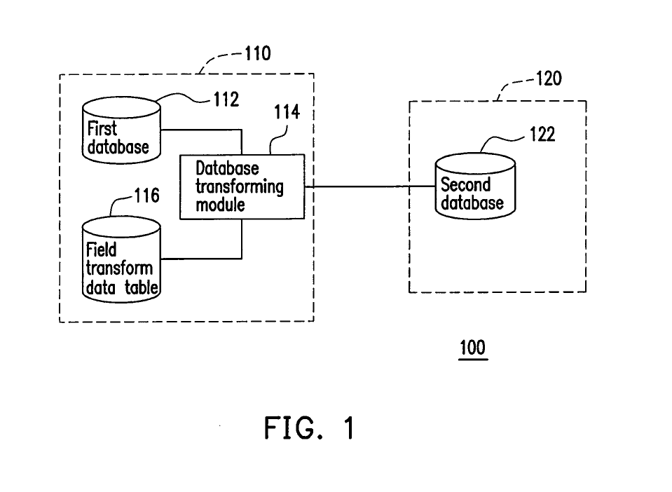

FIG. 1 is a diagram of a database transforming system according to an embodiment of the present invention. Referring to FIG. 1, the database transforming system 100 includes a first database 112, a second database 122, and a database transforming module 114. In the present embodiment, the first database 112 and the database transforming module 114 are disposed in a host 110, and the second database 122 is disposed in a mobile electronic device 120. The mobile electronic device 120 may be connected to the host 110 through a universal serial bus (USB) so that the second database 122 is connected to the first database 112 through the database transforming module 114 and accordingly data in the first database 112 can be written into the second database 122 through the compression and transformation of the database transforming module 114. In another embodiment of the present invention, the database transforming module 114 may also be disposed in the mobile electronic device 120 or another host, and it is within the scope of the present invention as long as the database transforming module 114 is connected to the first database 112 and the second database 122.

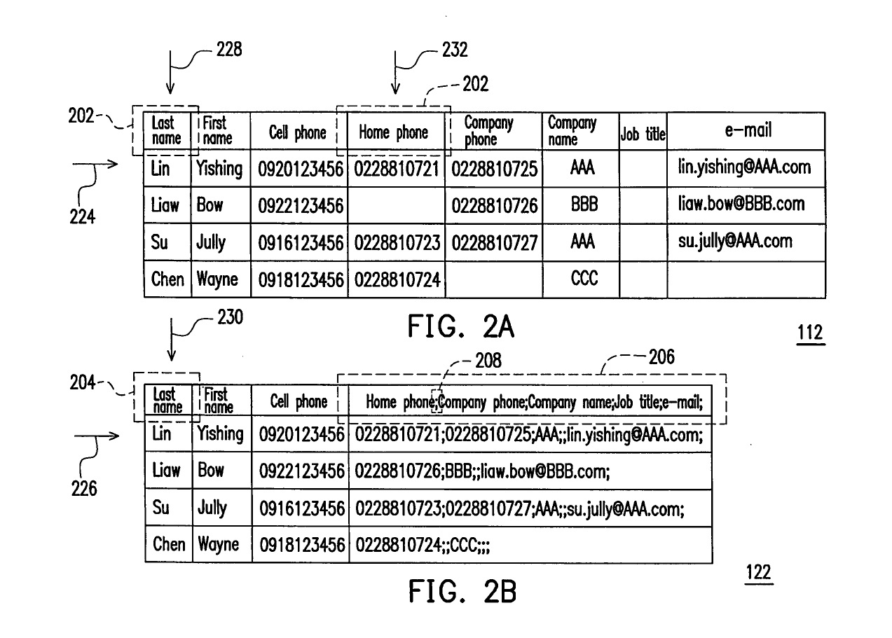

FIG. 2A and FIG. 2B are diagrams of the first database and the second database in FIG. 1. Please refer to FIG. 1, FIG. 2A, and FIG. 2B for the convenience of description. First, referring to FIG. 1 and FIG. 2A, the first database 112 includes a plurality of original fields 202 and 220, such as a “Last name” field, a “First name” field, a “Cell phone” field, and a “Home phone” etc. Referring to FIG. 1 and FIG. 2B, the second database 122 includes a plurality of main fields 204 and a composite field 206. The main fields 204 respectively store data in some of the original fields 202, such as the “Last name” field, the “First name” field, and the “Cell phone” field etc. The composite field 206 stores data in the other original fields 220 (as shown in FIG. 2A), such as the “Home phone; company phone; company name; job title; e-mail” field. In the composite field 206, data in each of the original fields 220 is separated by a separator, wherein the separator may be “;”.

FIG. 2C is a diagram of a field transform data table in FIG. 1. Referring to FIG. 1 and FIG. 2C, the database transforming module 114 transforms one of the original fields 202 and 220 (as shown in FIG. 2A) into one of the main fields 204 or the composite field 206 by reading the field transform data table 116. The operation will be described in detail in following paragraphs. The field transform data table 116 may include a first field 210 and a second field 212. The first field 210 stores the titles of the original fields 202 and 220 (as shown in FIG. 2A), and the second field 212 stores function indicators 218 of the original fields 202 and 220. The function indicators 218 of the original fields 202 and 220 have a first state 214 or a second state 216. The first state 214 may be “Y”, and the second state 216 may be “N”. Each of the fields can set to the first state 214 or the second state 216 by a user according to the actual requirement or the storage capacity of the mobile electronic device 120.

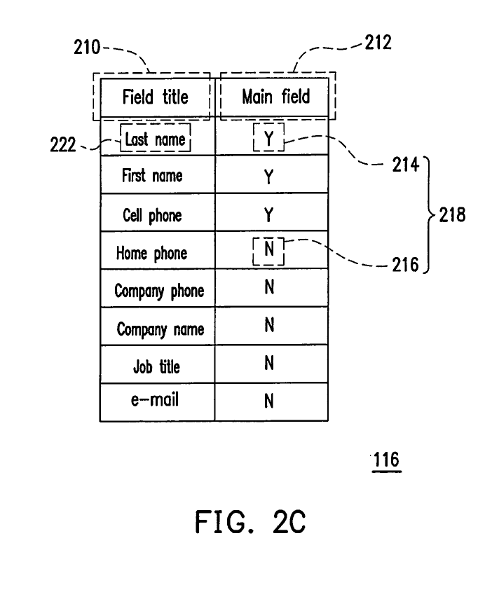

FIG. 3 is a flowchart illustrating a method for transforming the first database into the second database in FIG. 1. Referring to FIG. 1 and FIG. 3, the procedure for transforming the first database 112 into the second database 122 includes steps S302˜S310. First, in step S302, a plurality of main fields 204 (as shown in FIG. 2B) and a composite field 206 (as shown in FIG. 2B) are created in the second database 122. Next, data in the M^{th} tuple of the first database 112 is written into a buffer, such as a memory (not shown). After that, data is read from the memory, and whether or not the N^{th} field of the first database 112 is corresponding to one of the main fields 204 is determined. M and N are both positive integers. If the N^{th} field of the first database 112 is corresponding to one of the main fields 204, data in the N^{th} field of the M^{th} tuple is written into the corresponding main field 204 of the second database 122; otherwise, if the N^{th} field of the first database 112 is not corresponding to one of the main fields 204, data in the N^{th} field of the M^{th} tuple are written into the composite field 206 of the second database 122.

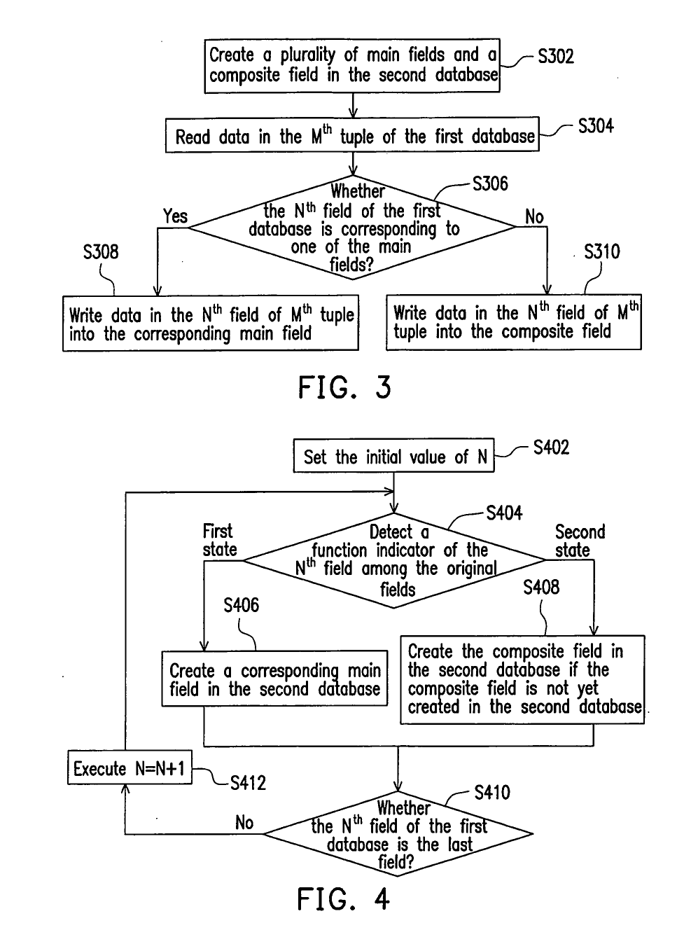

FIG. 4 is a flowchart illustrating the step in FIG. 3 for creating a field in the second database. To be specific, the step S302 (as shown in FIG. 3) may include steps S402˜S412, as shown in FIG. 4. First, an initial value of N is set (step S402). For example, N is set to 1, which means the subsequent steps are executed starting from the first field 228. Or, a range of N can be set for specifying the fields to be transformed from the first database 112 to the second database 122. Next, the database transforming module 114 reads and detects a function indicator 218 (as shown in FIG. 2C) of the N^{th} field among the original fields 202 and 220 (as shown in FIG. 2A) (step S404).

Thereafter, if the database transforming module 114 detects that the function indicator 218 of the N^{th} field is in the first state 214 (“Y”), the database transforming module 114 reads the corresponding field title 222 in the second field 212 from the second database 122 and creates a corresponding main field 204 in the second database 122 (step S406). If the database transforming module 114 detects that the function indicator 218 of the N^{th} field is in the second state 216 (“N”) and the composite field 206 is not yet created in the second database 122, the database transforming module 114 creates the composite field 206 in the second database 122 (step S408). After that, the database transforming module 114 determines whether or not the N^{th} field is the last field of the first database 112. If the N^{th} field is not the last field of the first database 112, N=N+1 is executed (step S412), and step S404 is repeated to process following fields. If the N^{th} field is the last field of the first database 112, the operation of creating new fields in the second database 122 is completed and following steps for transforming data in the first database 112 to the second database 122 can be performed.

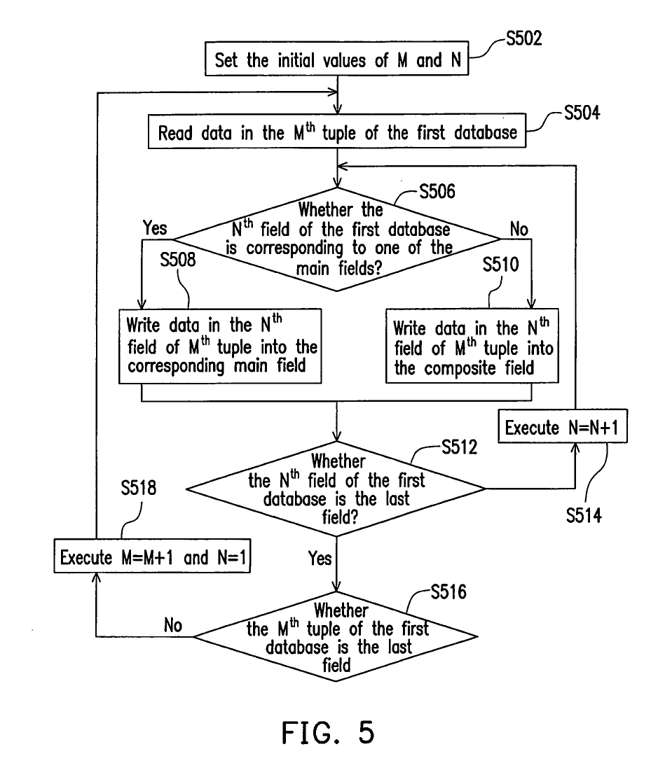

FIG. 5 is a flowchart illustrating the step in FIG. 3 for transforming data in the first database into the second database. Please refer to FIG. 5 and FIGS. 2A˜2C for the following description. First, in step S502, both the initial values of M and N are set to 1. Next, in step S504, data in the first tuple 224 (as shown in FIG. 2B) of the first database 112 is read into the memory, such as “Lin”, “Yishing”, and “0920123456” etc. Next, in step S506, the first state 214 “Y” corresponding to the “Last name” field is read from the field transform data table 116 (as shown in FIG. 2C) so that it is determined that the first field 228 is corresponding to the main field 204. After that, the data “Lin” in the first field 228 of the first database 112 is written into the first field 230 of the first tuple 226 of the second database 122. In step S512, since there are still other fields after the first field 228, step S514 is executed to increase the value of N by 1. Thereafter, the procedure returns to step S506 to re-execute foregoing steps.

If it is determined that the N^{th} field of the first database 112 is not corresponding to one of the main fields 204 in step S508, for example, if it is determined that the “Home phone” in the field transform data table 116 is corresponding to the second state 216 “N”, the data “022881072” in the 4^{th} field 232 of the first database 112 and a separator 208 “;” are written into the composite field 206 of the first tuple 226 of the second database 122, and so on, until all the data in the first tuple 224 of the first database 112 is written into the first tuple 226 of the second database 122. Next, in step S516, the value of M is increased by 1 and N is reset to its initial value 1, so as to transform data in the rest tuples of the first database 112 into the second database 122. After data is transformed from the first database 112 into the second database 122, the mobile electronic device 120 may also restore the composite field 206 into a plurality of fields in order to display the data content completely.

In overview, according to the present invention, a composite field is adopted for storing a plurality of original fields so that the storage space required by a database can be effectively reduced without losing any data. Moreover, the compressed database can be conveniently restored into its original field format to be displayed.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A database transforming method, suitable for transforming a first database having a plurality of original field of a host into a second database of a mobile electronic device, and the database transforming method comprising:
creating a plurality of main fields and a composite field in the second database used for displaying data in the original fields, wherein the main fields are respectively corresponding to at least one of the original fields, and each data displayed in the composite field is separated by a separator;
reading data in the M^{th} tuple of the first database, wherein M is a positive integer;
determining whether or not the N^{th} field of the first database is corresponding to one of the main fields, wherein N is a positive integer;
writing data in the N^{th} field of the M^{th} tuple of the first database into the corresponding main field, if the N^{th} field is corresponding to one of the main fields; and
writing data in the N^{th} field of the M^{th} tuple of the first database into the composite field, if the N^{th} field is not corresponding to one of the main fields.

2. The database transforming method according to claim 1, wherein the step of creating the main fields and the composite field in the second database comprises:
determining whether or not a function indicator of each of the original fields is in a first state; and
when the function indicator of one of the original fields is in the first state, creating a corresponding main field in the second database to allow data in the original field to be written into the corresponding main field.

3. The database transforming method according to claim 2, wherein the step of determining whether or not the N^{th} field of the first database is corresponding to one of the main fields comprises:
determining whether or not the function indicator of the N^{th} field among the original fields is in the first state.

4. The database transforming method according to claim 1, wherein the step of creating the main fields and the composite field in the second database further comprises:
determining whether or not a function indicator of each of the original fields is in a second state; and
when the function indicator of one of the original fields is in the second state and the composite field is not created yet, creating the composite field in the second database to allow data in the original field to be written into the composite field.

5. The database transforming method according to claim 1, wherein the step of creating the main fields and the composite field in the second database further comprises:
reading a function indicator from a field transform data table to determine whether or not to create one of the main fields or the composite field in the second database.

6. The database transforming method according to claim 5, wherein the field transform data table comprises:
a first field and a second field, wherein the titles of the original fields are stored into the first field, and the function indicators of the original fields are stored into the second field.

7. The database transforming method according to claim 1, wherein after the step of determining whether or not the N^{th} field of the first database is corresponding to one of the main fields, the database transforming method further comprises:
determining whether or not the N^{th} field of the first database is the last field; and
executing N=N+1 and executing the step of determining whether or not the N^{th} field of the first database is corresponding to one of the main fields again if the N^{th} field of the first database is not the last field.

8. The database transforming method according to claim 7 further comprising:
determining whether or not the M^{th} tuple of the first database is the last row if the N^{th} field of the first database is the last field; and
executing M=M+1 and N=1 and executing the step of reading the data again if the M^{th} tuple of the first database is not the last row.

9. A compressible database structure, suitable for a mobile electronic device to store a first database having a plurality of original fields of a host, and the compressible database structure comprising:
a plurality of main fields, for respectively storing data in a portion of the original fields; and
a composite field, for storing data in the another portion of the original fields, and separating the data in each of the original fields by a separator.

10. The compressible database structure according to claim 9 further comprising:
a field transform data table, comprising a first field and a second field, wherein the titles of the original fields are stored into the first field, and the a plurality of function indicators of the original fields are stored into the second field stores.

11. The compressible database structure according to claim 10, wherein the function indicators of the original fields have a first state or a second state, data in one of the original fields is stored into one of the main fields if the function indicator of the original field is in the first state, and data in one of the original fields is stored into the composite field if the function indicator of the original field is in the second state.

12. A database transforming system, comprising:
a first database, comprising a plurality of original fields;
a second database, comprising:
a plurality of main fields, for respectively storing data in a portion of the original fields;
a composite field, for storing data in the another portion of the original fields, wherein the data in each of the original fields stored into the composite field is separated by a separator; and
a database transforming module, for transforming the first database into the second database.

13. The database transforming system according to claim 12 further comprising:
a field transform data table, comprising a first field and a second field, wherein the titles of the original fields are stored into the first field, a plurality of function indicators of the original fields are stored into the second field, and the database transforming module transforms the first database into the second database according to the function indicators of the original fields.

14. The database transforming system according to claim 12, wherein the function indicators of the original fields have a first state or a second state, the database transforming module stores data in one of the original fields into one of the main fields if the function indicator of the original field is in the first state, and the database transforming module stores data in one of the original fields into the composite field if the function indicator of the original field is in the second state.

15. The database transforming system according to claim 12, wherein the first database is disposed in a host, the second database is disposed in a mobile electronic device, and the mobile electronic device is connected to the host.

16. The database transforming system according to claim 12, wherein the database transforming module is disposed in the host or the mobile electronic device.
